(19) United States
(12) Patent Application Publication
(10) Pub. No.: US 2021/0130078 A1
(43) Pub. Date: May 6, 2021

(54) Method and facility for refilling a container with a liquid

(71) Applicant: FILLON TECHNOLOGIES, FAVEROLLES (FR)

(72) Inventor: Aurélien BRULE, CHARTRES (FR)

(21) Appl. No.: 16/612,183

(22) PCT Filed: May 7, 2018
(86) PCT No.: PCT/FR2018/051146

§ 371 Date: Nov. 8, 2019

(30) Foreign Application Priority Data
May 16, 2017 (FR) 17 54290

(51) Int. Cl. B65D 83/62; B65B 3/04

(52) U.S. Cl. CPC B65D 83/62; B65D 83/425; B65B 3/045

(57) ABSTRACT

A method of assisting in refilling a container (11) with liquid, the container comprising a flexible pouch that is refillable with liquid, outer packaging (15) for the pouch, and a valve (16) for opening/closing the pouch, said pouch being a compressible pouch that can be shrunk inside the outer packaging (15) under the action of pressure exerted on the outside surface of the pouch, and said valve (16) comprising a valve body (17) provided with an orifice (18) and a shutter for the orifice (18) mounted to move inside the valve body (17) between an open position and a closed position for the orifice (18) so as to enable the pouch to be emptied when the pouch is in the compressed state and the orifice (18) of the valve (16) is open.

In order to refill the pouch subsequently with liquid, said method comprises a step of opening the orifice (18) of the valve (16), and a step of inflating the pouch by blowing gas into the inside of the pouch via the orifice (18) of the valve (16) in the open position.

### FIELD OF THE INVENTION

The invention relates to a method and to an installation for assisting in refilling a container with liquid.

The invention relates more particularly to a method of assisting in refilling a container with liquid, said container comprising a deformable flexible pouch that is refillable with liquid via a filling orifice, outer packaging for the pouch, and a valve for opening/closing the pouch, said pouch being a compressible pouch that can be shrunk inside the outer packaging under the action of pressure exerted on the outside surface of the pouch, and said valve comprising a valve body provided with an orifice of flow section that is less than the flow section of the filling orifice of the pouch together with a shutter for closing the orifice and mounted inside the valve body to move between a position in which the orifice is open and a position in which the orifice is closed so as to enable the pouch to be emptied when the pouch is in the compressed state and the orifice of the valve is open.

### PRIOR ART

Containers of the above-specified type are well known to persons skilled in the art. Because of the presence of a pouch, such containers have the advantage of making it possible to store a liquid that needs to have little contact with air, in particular in order to prevent premature evaporation of the liquid when the liquid contains a solvent. An example of such a container is described in International application WO 98/13292.

Nowadays, these containers are frequently used in installations for storing, selecting, and metering out base colors for fabricating paint, in particular in the automotive field, as illustrated in Patent EP 2 135 668, and they can be expected to be used in other fields in the future.

Given the design of the containers, when liquid is extracted from a container, the pouch shrinks, such that once the container is empty, the pouch is fully shrunk inside its outer packaging. In order to be able to refill the container, the pouch needs to be put back into place as it was initially, inside the outer packaging. The weight of the liquid for filling the pouch is generally not sufficient to put said pouch back into place.

In order to overcome this problem, users take a mixer that is in the form of a rod, and they use the rod to push the pouch back inside the outer packaging so that it returns to its place therein.

This leads to risks of damaging the flexible pouch by puncturing it, or of the mixer inserting foreign bodies into the pouch, which foreign bodies might then soil the content of the pouch and consequently block operation of the valve.

### OBJECTS AND SUMMARY

An object of the invention is to propose a method and a device for assisting in refilling that enable the pouch to be put back into place without intrusive intervention and that do not require the installation to be cleaned after each occasion the pouch is put back into place.

For this purpose, the invention provides a method of assisting in refilling a container with liquid, said container comprising a deformable flexible pouch that is refillable with liquid via a filling orifice, outer packaging for the pouch, and a valve for opening/closing the pouch, said pouch being a compressible pouch that can be shrunk inside the outer packaging under the action of pressure exerted on the outside surface of the pouch, and said valve comprising a valve body provided with an orifice of flow section that is less than the flow section of the filling orifice together with a shutter for closing the orifice of the valve and mounted inside the valve body to move between a position in which the orifice is open and a position in which the orifice is closed so as to enable the pouch to be emptied when the pouch is in the compressed state and the orifice of the valve is open; said method being characterized in that, in order to refill the pouch subsequently with liquid, it comprises a step of opening the orifice of the valve, and a step of inflating the pouch by blowing gas into the inside of the pouch via the orifice of the valve in the open position.

In order to refill the pouch subsequently with liquid, and with the valve orifice in the open state, the method thus comprises a step of inflating the pouch by blowing gas into the inside of the pouch via the orifice of the valve in the open position.

Using the orifice of the valve for inflating the pouch makes it possible in simple manner to obtain sealing between the coupling and the valve, and makes it easy to guide air into the inside of the pouch.

Inflating the pouch via the orifice of the valve serves to limit any risk of soiling the coupling.

In an implementation of the method, the shutter of the valve is made at least in part out of a magnetic material and is urged by means of an elastically deformable member towards the position in which the orifice of the valve is closed, and, during the step of opening the orifice of the valve, the shutter of the valve is caused to move in the direction for opening the orifice of the valve by using a magnetic or electromagnetic control system.

Using a magnetic or electromagnetic control system enables the pouch to be inflated in parallel with keeping the orifice of the valve in the open state.

Using a magnetic control system comprising at least one magnetic element enables the method to be performed in an explosive atmosphere at low cost.

The invention also provides an installation for assisting in refilling a container with liquid, said container comprising a deformable flexible pouch that is refillable with liquid via a filling orifice, outer packaging for the pouch, and a valve for opening/closing the pouch, said pouch being a compressible pouch that can be shrunk inside the outer packaging under the action of pressure exerted on the outside surface of the pouch, and said valve comprising a valve body provided with an orifice of flow section that is less than the flow section of the filling orifice together with a shutter for closing the orifice of the valve and mounted inside the valve body to move between a position in which the orifice is open and a position in which the orifice is closed so as to enable the pouch to be emptied when the pouch is in the compressed state and the orifice of the valve is open; the installation being characterized in that it comprises a stand defining a location for receiving the valve of the container and into which at least a portion of the valve of the container is suitable for being inserted, a control system for causing the valve to open, which control system is suitable for being positioned around said location for receiving the valve, the control system being suitable for enabling the orifice of the valve of the container to be opened when the valve is in its state in position inside said location, and a coupling suitable for connecting firstly to a source of gas under pressure and secondly to the valve, said coupling being suitable for being positioned at least in part around the location for receiving the valve in a position in which the coupling covers a zone of the location that is suitable for being occupied at least in part by the orifice of the valve when the valve is in its state arranged inside said location, so as to make it possible, when the valve is in its state in position in said location and when the orifice of the valve is in its open position, to feed the pouch with gas in the direction for inflating the pouch.

By means of such an installation, it is possible, when the valve is in its state in position in the location of the installation for receiving the valve, to keep the orifice of the valve in the open position in parallel with inflating the pouch.

Using the orifice of the valve for inflating the pouch limits any risk of the installation coming into contact with the remainder of liquid contained in the pouch.

In an embodiment of the invention, the location for receiving the valve of the container comprises a through housing within which the valve is suitable for being housed at least in part, the through housing being suitable for being closed at one end by at least a portion of the coupling.

In an embodiment of the installation, at least a portion of the coupling is movably mounted on said stand to move the coupling between a position spaced apart from the location for receiving the valve and its position close to the location for receiving the valve in which it is arranged at least in part around the location for receiving the valve and in which it covers the zone of the location for receiving the valve of the container that is suitable for being occupied by the orifice of the valve when the valve is in its state arranged inside said location.

Preferably, the movable portion of the coupling is pivotally mounted on said stand.

In an embodiment of the installation, the control system for causing the valve to open comprises at least one magnetic or electromagnetic control element. This results in simplifying use of the installation.

In an embodiment of the installation, said at least one magnetic or electromagnetic control element is positioned around said through housing of the location for receiving the valve.

In an embodiment of the installation, the coupling is a coupling that is closable by a closure member mounted to move between a closed position and an open position.

In an embodiment of the installation, the closure member is configured to pass from the closed position of the coupling to the open position of the coupling during the movement of said coupling towards the location for receiving the valve.

Thus, by putting the coupling into position in the configuration in which it covers in sealed manner the zone of the location for receiving the valve of the container that is suitable for being occupied by the orifice of the valve when the valve is in its state arranged inside said location it becomes possible, in parallel, to cause said coupling to be fed with air. Once more, this results in simplifying use of the installation.

In an embodiment of the invention, the stand comprises a post that is held upright, and from which the location for receiving the valve projects in cantilevered manner.

The invention also provides an assembly comprising a valve container and an installation for assisting in refilling said container with liquid, said container comprising a deformable flexible pouch that is refillable with liquid via a filling orifice, outer packaging for the pouch, and a valve for opening/closing the pouch, said pouch being a compressible pouch that can be shrunk inside the outer packaging under the action of pressure exerted on the outside surface of the pouch, and said valve comprising a valve body provided with an orifice of flow section that is less than the flow section of the filling orifice together with a shutter for closing the orifice of the valve and mounted inside the valve body to move between a position in which the orifice is open and a position in which the orifice is closed so as to enable the pouch to be emptied when the pouch is in the compressed state and the orifice of the valve is open, the assembly being characterized in that the installation is of the above-specified type.

### BRIEF DESCRIPTION OF THE FIGURES

The invention can be well understood on reading the following description of embodiments, given with reference to the accompanying drawings, in which:

FIG. 1 is a perspective view of an installation in accordance with the invention, with the coupling in its position spaced apart from the valve reception location of the installation.

FIG. 2 is a perspective view of an installation in accordance with the invention, with the coupling in its position close to the valve reception location of the installation, in which it covers the zone of said location that is suitable for being occupied, at least in part, by the orifice of the valve when the valve is in its state positioned in said location.

FIG. 3 is a perspective view of the FIG. 2 installation seen from a different angle.

FIG. 4 is a perspective view of the FIG. 2 installation seen from a different angle.

FIG. 5 is a section view of an installation in accordance with the invention, with the pouch in a partially-shrunk position.

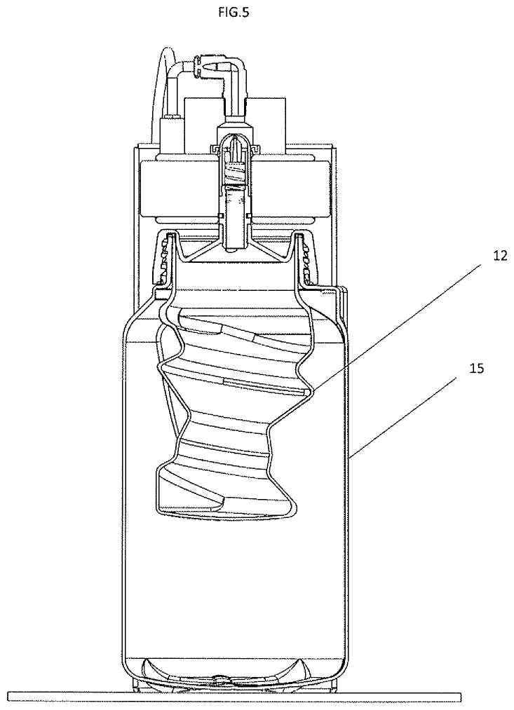

FIG. 6 is a section view of a container in accordance with the invention with the pouch in a non-shrunk position inside the outer packaging.

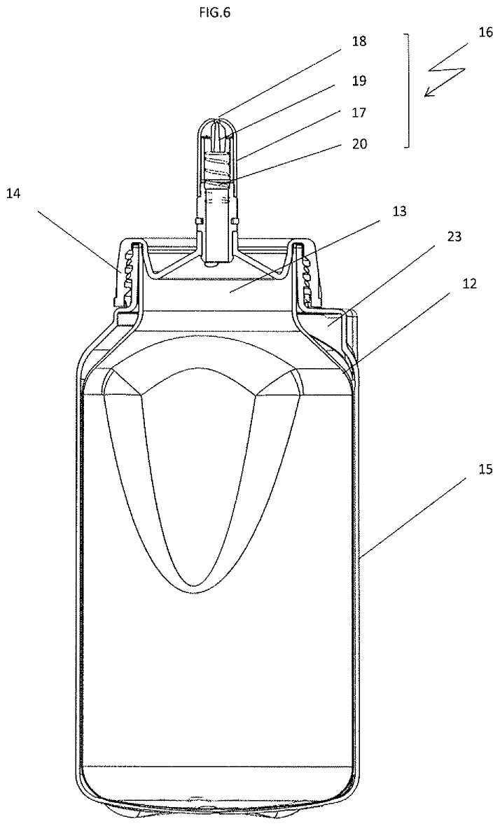

FIG. 7 is a perspective view of a container with its filler orifice in the open state.

FIG. 8 is two fragmentary sectional views of the top portion of a container, in the closed position of the valve orifice (top view on the sheet) and in the open position of the valve orifice (bottom view on the sheet).

### DETAILED DESCRIPTION

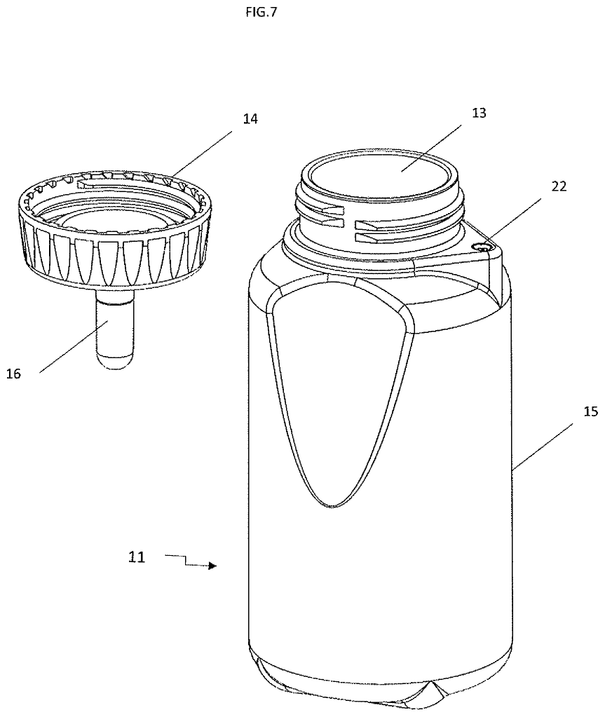

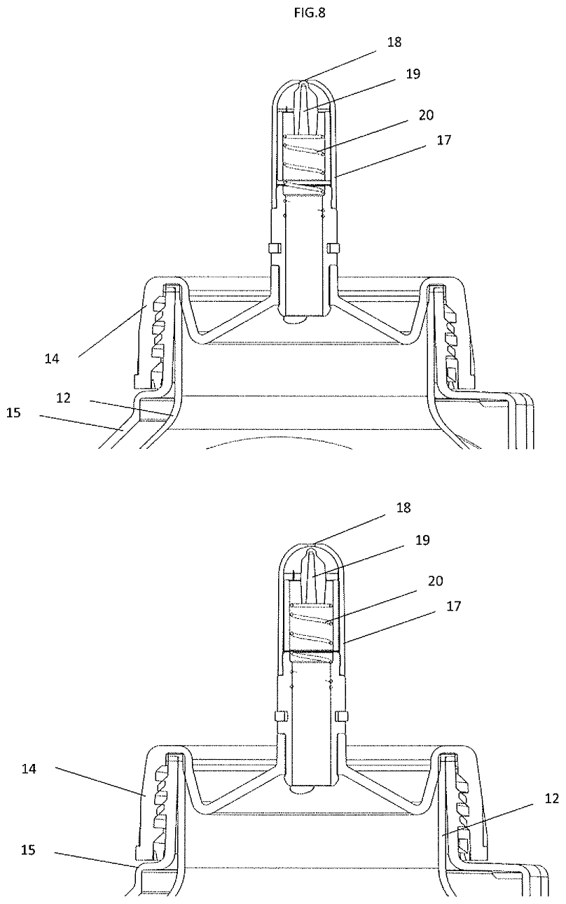

As mentioned above, the invention provides an installation and a method for assisting in refilling with liquid a container 11 of the type shown in FIG. 7, and in detail views in FIG. 8.

The container comprises a deformable flexible pouch 12 and outer packaging 15 for the pouch 12. In this example, this outer packaging 15, which constitutes a rigid or semi rigid shell for protecting the pouch 12, is in the form of an elongate body provided with a neck, thereby giving it the appearance of a jar. The pouch 12 is received inside of the outer packaging 15 and is pressed at least in part against the inside wall of the outer packaging 15.

The pouch 12 presents an opening surrounded by a collar, which collar is pressed against the top or outer peripheral edge of the neck of the jar constituting the outer packaging 15.

Because the body of the pouch presents a circumference that is greater than the circumference of the neck of the outer packaging, the pouch cannot move out from the outer packaging. It is also possible for the pouch 12 to be bonded locally to the outer packaging 15.

Thus, the pouch 12 is held inside the outer packaging 15.

At the neck of the outer packaging, the pouch 12 thus has an opening that constitutes the orifice 13 for filling the pouch 12 with liquid. This filling orifice 13 is closed by means of a stopper 14, which is screwed onto the neck of the outer packaging 15. The stopper 14 is provided with a gasket that provides sealing for the closure between the pouch and the stopper. The pouch could be provided with a filling orifice 13 at some other location, without going beyond the ambit of the invention.

The stopper 14 is fitted with a valve 16 for opening/closing the pouch. The valve 16 comprises a valve body 17 having an orifice 18 of flow section smaller than the flow section of the filling orifice 13, and a shutter 19 for shutting the orifice 18, which shutter is mounted inside the valve body 17 to move between a position in which the orifice 18 is open and a position in which the orifice 18 is closed so as to enable the pouch 12 to be emptied when the pouch 12 is in the compressed state and when the orifice 18 of the valve 16 is in the open state. The shutter 19 is slidably movable inside the valve body 17.

The valve shutter 19 is urged towards the position in which the orifice 18 of the valve 16 is closed by means of an elastically-deformable member 20, specifically a helical spring in this example.

In the example shown in FIG. 8, the valve body is in the shape of a glove finger, as described in Patent EP 1 975 486, and the orifice 18 of the valve is positioned at the end of said finger. The base of the finger communicates with the inside of the pouch. When in its open position, the orifice 18 of the valve 16 is used conventionally in order to enable the pouch 12 to be emptied.

The pouch 12 is emptied by compressing the pouch 12 under the action of pressure exerted on the outside surface of the pouch 12. This pressure may be exerted in various ways. In the examples shown, the outside surface of the pouch 12 cooperates with the inside surface of the outer packaging to define a closed space 23 that is in communication with the outside via an orifice provided in the outer packaging, and given reference 22 in the figures.

During the stage of emptying the pouch, this orifice 22 may be connected to a source of gas under pressure in order to put the closed volume under pressure.

Putting the closed volume under pressure in this way leads to the pouch 12 being compressed, thereby enabling the pouch 12 to be emptied when the orifice 18 of the valve 16 is in its open position.

While it is being emptied, the pouch 12 thus tends to shrink inside the outer packaging. Once fully shrunk inside the outer packaging, in order to refill the pouch, it is necessary to redeploy it and to reposition it at least in part so that it is bearing against the inside of the outer packaging.

To do this, it is necessary to open the orifice 18 of the valve 16 and to inflate the pouch 12 by blowing air into the inside of the pouch 12 via the orifice 18 of the valve 16 while it is in the open position.

The orifice 18 of the valve 16 is then no longer used as an orifice for emptying liquid from the pouch, but rather as an orifice for filling the pouch 12 with gas.

In order to make such filling possible, it is necessary for the orifice 22 in the outer packaging to be connected to an exhaust, assuming it was previously connected to a source of fluid under pressure.

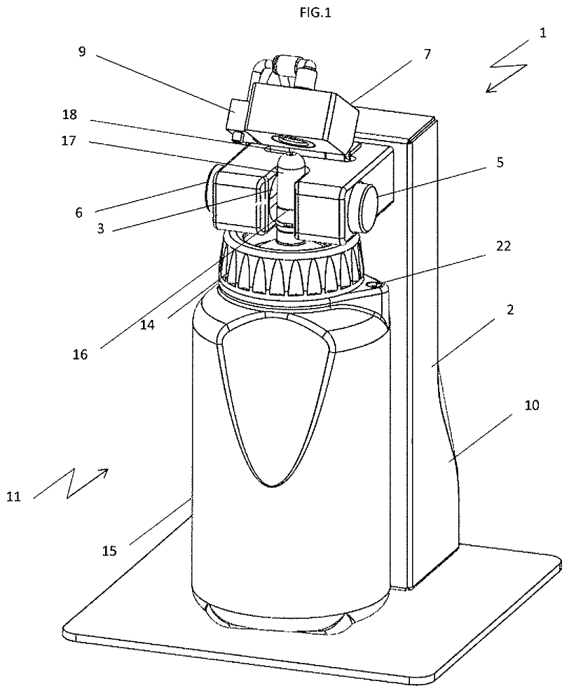

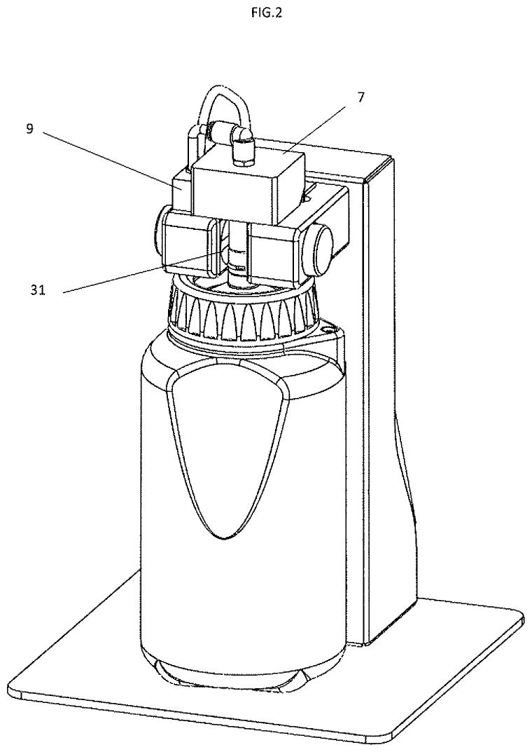

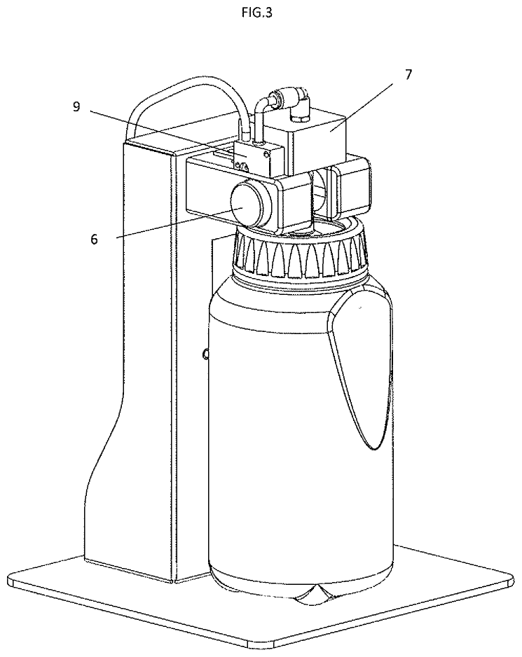

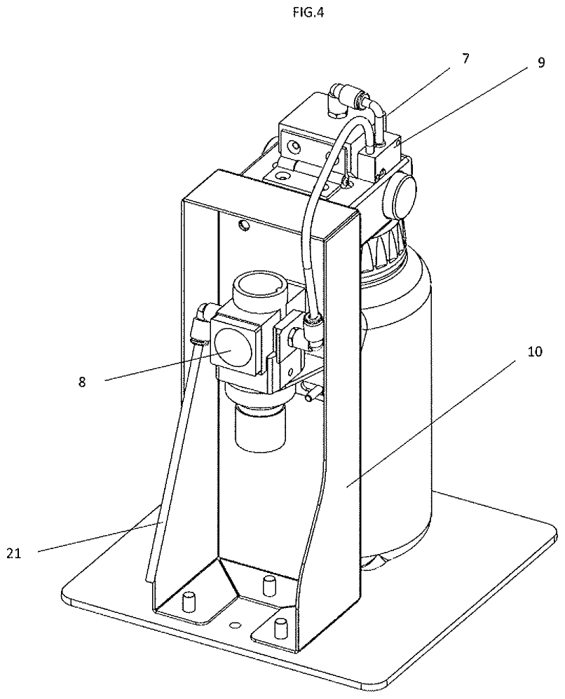

In order to be able to perform this step of inflating the pouch, it is possible to use an installation as shown in FIGS. 1 to 4.

The installation 1 comprises a stand 2 defining a location 3 for receiving the valve 16 of the container 11.

In the example shown, the stand 2 comprises a post 10 that is held upright, and from which the location 3 for receiving the valve 16 projects in cantilevered manner.

In order to keep the post 10 in the upright state, the base of said post is secured to a plate so that the post stands up from said plate.

The reception location 3 is arranged at least partially as a part having the shape of a prone letter U. The back of the core of the U-shape is fastened to the post, so that the branches of the U-shape extend in a horizontal plane parallel to the plane of the plate supporting the post, i.e. parallel to the plane on which the installation stands.

The empty space left free between the branches of the U-shape forms a through housing 31 within which the valve is suitable for being received in part when the container is in its state with the bottom of the outer packaging in position on the plate of the installation.

In this position, the end of the valve with the orifice 18 projects from the housing above the U-shaped part, so that it can be covered by a coupling 7, which is described below. Thus, in this installation, the location 3 for receiving the valve 16 of the container 11 comprises a through housing 31 within which the valve 16 is suitable for being housed at least in part, this through housing 31 being suitable for being closed at one end by at least a portion of the coupling 7.

The installation 1 also comprises a control system 5 for causing the valve to open and arranged around the location 3 for receiving the valve 16. This control system 5 for opening the valve 16 comprises one or more magnetic control elements 6, and specifically in this example two magnets.

The two magnets, which are preferably of neodymium type, are positioned on either side of the valve 16 when the valve is in its state in position in its location, in such a manner that the force exerted by these magnets is sufficient, and in particular is greater than the return force of the elastically-deformable member 20 tending to return the shutter 19 into its position closing the orifice 18 of the valve 16, so as to attract the shutter made of a magnetic material, e.g. magnetic stainless steel, towards the end of the valve remote from its end having the orifice 18 of the valve 16 and referred to as its “breech”. The valve 16 is then open.

When the valve is taken away from between the magnets, the return spring 20 then re-closes the valve.

In this example, each of the two magnets is positioned in a respective branch of the above-described U-shaped part. Each of these two magnets has two poles, a north pole and a south pole. A magnetic field exists between these two poles. It is this magnetic field that attracts the shutter 19 made of a magnetic material. It thus suffices to position the magnets on the U-shaped part with their north poles facing each other and with their south poles facing each other, such that once the valve is placed between said magnets, the shutter is moved and taken to a position corresponding to the open position of the valve orifice.

In order to open the valve, a single magnet might suffice, but using two magnets guarantees that the orifice of the valve is opened reliably.

The above-described control system 5 thus has at least two magnets in facing positions around the location 3 for receiving the valve.

The above-described control system 5 is thus configured to enable the orifice 18 of the valve 16 of the container 11 to be opened when the valve is in its state in position inside said location 3.

In a variant, the control element of the control system 5 could be an electromagnetic element, such as an electromagnetic coil or a solenoid.

The drawback of such a system, when used in a so-called “ATEX” (explosive atmosphere) zone, is that it requires major and often burdensome protection measures in order to be able to comply with regulations.

The installation also has a coupling 7 that is connectable firstly to a source 21 of gas under pressure, and secondly to the valve 16.

The coupling 7 is positioned at least in part around the location 3 for receiving the valve 16 in a position in which the coupling covers a zone of the location 3 suitable for being occupied at least in part by the orifice of the valve 16 when the valve 16 is in its state arranged inside said location 3 so as to make it possible, when the valve is in its state positioned in said location 3 and the orifice 18 of the valve 16 is in its open position, to feed gas into the pouch 12 in the direction for inflating the pouch 12.

In the example shown, the coupling 7 is positioned above the U-shaped part and is hinged to the U-shaped part via a hinge connection.

This coupling 7 forms a gas flow pipe that terminates at one end in a pivotal endpiece that covers a portion of the valve that projects from the through housing 31, and that is suitable at its other end for connecting to a source 21 of gas under pressure, in particular to a compressor or to some other generator of compressed air.

The endpiece of the pipe thus forms the portion of the coupling 7 that is pivotally mounted on the stand 2 in order to move the coupling 7 between a position spaced apart from the location 3 for receiving the valve 16, and the position close to the location 3 for receiving the valve 16 in which it is placed at least in part around the valve reception location 3 and covers the zone of the location 3 for receiving the valve of the container 11 that is suitable for being occupied by the orifice 18 of the valve when the valve 16 is placed in its state inside said location 3. This pivotal portion of the coupling closes the end of the housing 31.

The gas flow pipe closed by the coupling 7 is a closable connection. Specifically, the coupling 7 is a coupling that is closable by a closure member 9 mounted to move between a closed position and an open position.

This closure member 9 may be a pneumatic contactor constrained to move with the endpiece. The closure member is configured to pass from the closed position of the coupling 7 to the open position of the coupling 7 when the pivotal portion of the coupling 7 moves towards the location 3 for receiving the valve 16.

This closure member 9 may thus comprise a spring-biased ball occupying an open position of the resulting gas flow pipe when the coupling is close to the valve reception location 3.

Thus, the above-described installation operates as follows: assume that the pouch of the container has been emptied by applying pressure on the pouch, via the orifice 22 in the outer packaging, such that the pouch has shrunk inside the outer packaging.

The container is then placed in the installation, with the valve positioned between the magnets 6, as shown in FIG. 1.

The orifice 18 of the valve 16 is then in the open position, the shutter 19 of the orifice 18 being moved into the open position for the orifice 18 against the return member 20 under the action of a magnetic attraction or repulsion force exerted by the magnets on said shutter 19.

The pivoting portion or endpiece of the coupling 7 is pivoted to cover the end of the valve having the orifice 18 of the valve, without giving rise to direct contact between the orifice 18 of the valve and the coupling 7. This pivoting portion of the coupling may be provided internally with a sealing ring in order to isolate the orifice 18 of the valve from the outside and improve the effectiveness of inflation.

The closure member 9 of the coupling is then in the open position. Air at low pressure, in the range 0.1 bar to 0.5 bar, is sent into the pouch via said orifice 18 of the valve 16, so as to put the pouch back into place inside the outer packaging.

In order to guarantee that the pressure is low in order to prevent any bursting of the pouch 12, a pressure regulator 8 may be arranged in the pipe for feeding gas to the orifice 18 of the valve.

Inflating the pouch generally takes ten seconds to twenty seconds. From the sound produced, the operator detects that the pouch is in place, i.e. generally pressed at least in part against the outer packaging.

It should be observed that during this operation of putting the pouch back into place, the installation does not, at any moment, come into direct contact with the liquid contained in the pouch. Specifically, even if the coupling covers the end of the valve body that has the orifice 18 of the valve, the coupling is configured so as to surround the orifice 18 of the valve without touching it, which orifice 18 might be soiled by the liquid from the content of the pouch.

It is thus possible to go from one container to another without any need to clean the installation.

Once inflation has terminated, it suffices to move the pivotal portion of the coupling away from the valve reception location. The closure member 9 closes the pneumatic circuit. The valve of the container may be extracted from its location, with the return spring 20 then returning the shutter into its position for closing the orifice of the valve, the shutter no longer being subjected to the action of the magnets driving it into its position for opening the orifice 18 of the valve.

A new container may be installed in the installation for a new operation of inflating a pouch.

1. A method of assisting in refilling a container with liquid, said container comprising:
a deformable flexible pouch that is refillable with liquid via a filling orifice, outer packaging for the pouch, and a valve for opening/closing the pouch, said pouch being a compressible pouch that can be shrunk inside the outer packaging under the action of pressure exerted on the outside surface of the pouch, and said valve comprising a valve body provided with an orifice of flow section that is less than the flow section of the filling orifice of the pouch together with a shutter for closing the orifice and mounted inside the valve body to move between a position in which the orifice is open and a position in which the orifice is closed so as to enable the pouch to be emptied when the pouch is in the compressed state and the orifice of the valve is open; wherein, in order to refill the pouch subsequently with liquid, wherein said method comprises a step of opening the orifice of the valve, and a step of inflating the pouch by blowing gas into the inside of the pouch via the orifice of the valve in the open position.

2. A method according to claim 1;
wherein the shutter of the valve is made at least in part out of a magnetic material and is urged by means of an elastically deformable member towards the position in which the orifice of the valve is closed, and in that, during the step of opening the orifice of the valve, the shutter of the valve is caused to move in the direction for opening the orifice of the valve by using a magnetic or electromagnetic control system.

3. An installation for assisting in refilling a container with liquid, said container comprising a deformable flexible pouch that is refillable with liquid via a filling orifice, outer packaging for the pouch, and a valve for opening/closing the pouch, said pouch being a compressible pouch that can be shrunk inside the outer packaging under the action of pressure exerted on the outside surface of the pouch, and said valve comprising a valve body provided with an orifice of flow section that is less than the flow section of the filling orifice together with a shutter for closing the orifice of the valve and mounted inside the valve body to move between a position in which the orifice is open and a position in which the orifice is closed so as to enable the pouch to be emptied when the pouch is in the compressed state and the orifice of the valve is open; wherein said installation comprises a stand defining a location for receiving the valve of the container and into which at least a portion of the valve of the container is suitable for being inserted, a control system for causing the valve to open, which control system is suitable for being positioned around said location for receiving the valve, the control system being suitable for enabling the orifice of the valve of the container (11) to be opened when the valve is in its state in position inside said location, and a coupling suitable for connecting firstly to a source of gas under pressure and secondly to the valve, said coupling being suitable for being positioned at least in part around the location for receiving the valve in a position in which the coupling covers a zone of the location that is suitable for being occupied at least in part by the orifice of the valve when the valve is in its state arranged inside said location, so as to make it possible, when the valve is in its state in position in said location and when the orifice of the valve is in its open position, to feed the pouch with gas in the direction for inflating the pouch.

4. An installation according to claim 3;
wherein the location for receiving the valve of the container comprises a through housing within which the valve is suitable for being housed at least in part, the through housing being suitable for being closed at one end by at least a portion of the coupling.

5. An installation according to claim 3;
wherein at least a portion of the coupling is movably mounted on said stand to move the coupling between a position spaced apart from the location for receiving the valve and its position close to the location for receiving the valve in which it is arranged at least in part around the location for receiving the valve and in which it covers the zone of the location for receiving the valve of the container that is suitable for being occupied by the orifice of the valve when the valve is in its state arranged inside said location.

6. An installation according to claim 3, for a container of the type in which the shutter for the orifice of the valve is made of a magnetic material and is urged by means of an elastically deformable member into its position for closing the orifice of the valve, the installation being characterized in that the control system for causing the valve to open comprises at least one magnetic or electromagnetic control element.

7. An installation according to claim 11,
wherein said at least one magnetic or electromagnetic control element (6) is positioned around said through housing (31) of the location (3) for receiving the valve (16).

8. An installation according to claim 3;
wherein the coupling is a coupling that is closable by means of a closure member mounted to move between a closed position and an open position.

9. An installation according to claim 12,
wherein the closure member is configured to pass from the closed position of the coupling to the open position of the coupling during the movement of said coupling towards the location for receiving the valve.

10. An installation according to claim 3;
characterized in that the stand comprises a post held in the upright state and from which the location for receiving the valve projects in a cantilevered position relative to said post.

11. An installation according to claim 4, for a container of the type in which the shutter for the orifice of the valve is made of a magnetic material and is urged by means of an elastically deformable member into its position for closing the orifice of the valve, the installation being characterized in that the control system for causing the valve to open comprises at least one magnetic or electromagnetic control element.

12. An installation according to claim 8;
wherein the coupling is a coupling that is closable by means of a closure member mounted to move between a closed position and an open position.
